(19) United States
(12) Patent Application Publication
(10) Pub. No.: US 2008/0301239 A1
(43) Pub. Date: Dec. 4, 2008

(54) REMOTE ADMINISTRATION OF DEVICES AND RESOURCES USING AN INSTANT MESSENGER SERVICE

(75) Inventors: Pavel Khijniak, Redmond, WA (US); Henrik Frystyk Nielsen, Hunts Point, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/756,591

(22) Filed: May 31, 2007

(51) Int. Cl. G06F 15/16

(52) U.S. Cl. 709/206

(57) ABSTRACT

Various implementations are described herein for using instant messenger services to administer devices. Both devices and administrators have corresponding client instant messenger services that enable administrators to configure the devices, update firmware and/or software applications running on the devices, control the devices, facilitate communication between the devices and resources such as technicians, web services and so forth. Further, devices are also able to initiate communication with administrators and/or resources to request configuration, updates to firmware and/or software applications running on the devices, troubleshooting services from technicians, send alerts and so forth.

### BACKGROUND

Instant messenger services are typically used by people to chat and exchange information. Individuals sign up for an account and request a unique identifier to identify them to other users. Individuals create contact lists including unique identifiers of other users. The instant messenger service alerts an individual when a user included in the individual's contact list is online and enables instant communication between the individual and the other user. Instant messenger services have evolved over the years, from providing text-only chat sessions between two or more users, to supporting dynamic sessions including the ability to send pictures and play games. However, users of instant messenger services are people.

### SUMMARY

The following presents a simplified summary of the disclosure to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Described herein are implementations for using an instant messenger service to remotely administer a device. Administrators via instant messenger services are able to configure devices, update firmware and/or software running on devices, control devices, facilitate communication between devices and resources such as technicians and so forth.

Devices and resources use client instant messenger services that allow them to access instant messenger services. Each client instant messenger service includes a unique identifier that is associated with a user of the client instant messenger service. Instant messenger services use the unique identifiers to authenticate users to grant access to the messaging system. Once users are granted access to instant messenger services, they receive their corresponding contact lists and may received presence and status information related to other users of the instant messenger service included in their contact lists.

Devices include firmware and/or software applications that communicate with administrators and/or resources via instant messenger services using the client instant messenger services. Firmware and/or software applications include logic to process messages received by client instant messengers via instant messenger services and to send messages using client instant messenger services via instant messenger services.

Resources interact with devices and may provide additional services and/or features for the devices. Examples of resources include but are not limited to people, web services, other devices and so forth. Administrators, a type of resource, are able to configure, update, control one or more devices and facilitate communication between devices and resources by sending one or more messages via an instant messenger service. Technicians, also a type of resource, are able to troubleshoot, configure, update, or control one or more devices by sending one or more messages via an instant messenger service.

Client instant messenger services may be augmented with plug-ins and/or other extensions to provide a rich user interface specifically tailored for interacting with a device. In this way, administrators and/or technicians may have user interfaces specifically crafted for a device to aid in administration, troubleshooting, servicing, control and so forth. Devices may provide specific user interface information that determines what controls are included in user interfaces and how the user interfaces are displayed. Typically, the user interface information provided by devices is generated as needed by the device and is specific to behavior and/or status related to the device.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates an exemplary environment for an administrator to configure, update and/or control a device and to facilitate communication between the device and a resource using an instant messenger service.

FIG. 2 illustrates a flow chart depicting an exemplary implementation for a device to connect to an instant messenger service and for an administrator to configure the device via the instant messenger service.

FIG. 3 illustrates a flow chart depicting an exemplary implementation for an administrator to update a device via an instant messenger service.

FIG. 4 illustrates an exemplary environment for an administrator using an instant messenger service to facilitate communication between a device and a technician that will troubleshoot the device.

FIG. 5 illustrates a flow chart depicting an exemplary implementation for an administrator using an instant messenger service to facilitate communication between the device and a technician that will troubleshoot the device.

### DETAILED DESCRIPTION

### Overview

The detailed description below describes implementations that allow a human to remotely interact with a device using an instant messenger service such as Windows Live Messenger™, Yahoo Messenger™, AOL Instant Messenger™ and so forth. Using the instant messenger service, an individual can configure the device, update the software running on the device, command the device to perform various actions, facilitate communication between the device and a third party web service, device, or person such as a technician, and so forth. Further, in the below described implementations, the technician can troubleshoot the device. Note that similar to how a human interacts with devices via an instant messenger service, a web service may also interact with the devices. For example, configuring devices could be performed by a human administrator sending one or more commands, or by a web service that is programmed to send one or more commands. Because instant messenger services are ubiquitous and are designed to communicate through firewalls and network address translation (NAT) boxes, they provide a suitable communication infrastructure to remotely administer devices that overcome many of the problems other current solutions have. Further, administering devices using instant messenger services removes the need for administrators to have specific knowledge of each device's local network configuration and the need for administrators to have authority to modify the local network security settings.

### General Environment

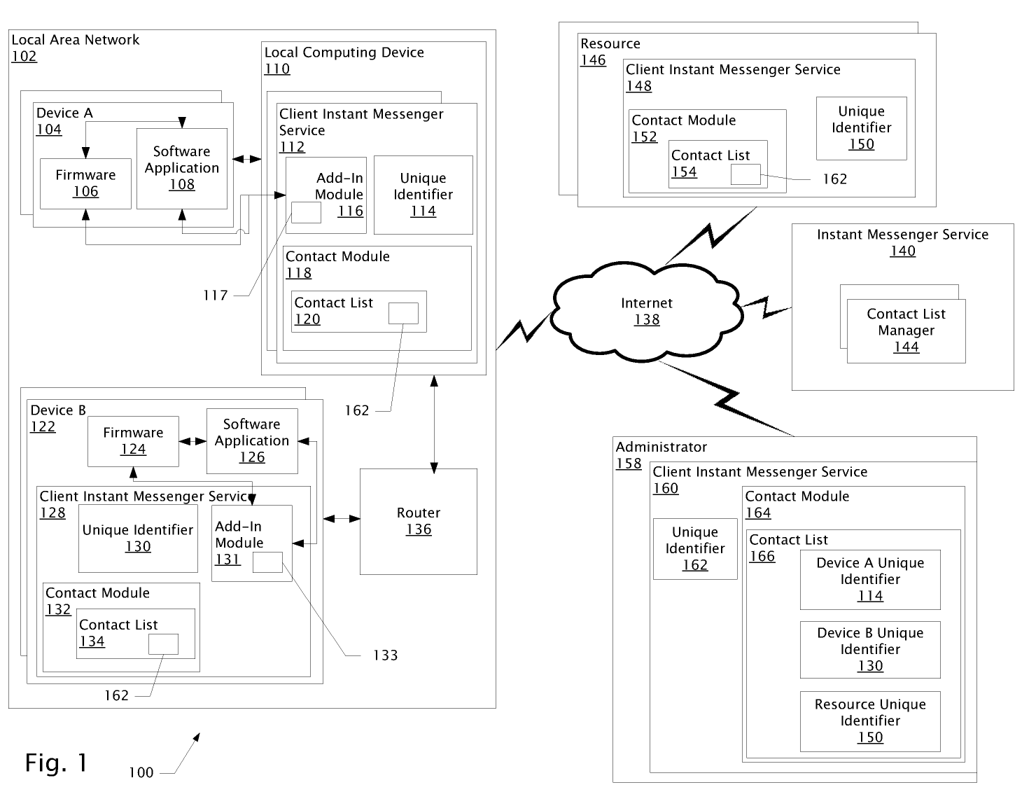

FIG. 1 illustrates an example implementation of an administrator configuring, updating and/or controlling a device and/or facilitating communication between a device and a resource. The implementation in FIG. 1 has been deliberately expanded to illustrate various aspects that are possible with the instant disclosure. Not all of the elements illustrated in FIG. 1 are required in every embodiment and the various elements may be put together in different ways to implement different systems.

FIG. 1 illustrates an exemplary environment 100 which includes Device A 104 and Device B 122. Device A 104 and Device B 122 represent devices that are administered, controlled and otherwise subject to administrator 158. Environment 100 also includes instant messenger service 140 that provides a communication infrastructure. As illustrated in FIG. 1, environment 100 also includes resource 146 which represents any number or type of resource that interacts with Device A 104 and Device B 122.

### Instant Messenger Service

Instant messenger service 140 is a messaging system that enables an individual to communicate with one or more users of instant messenger service 140. Instant messenger service 140 may be implemented as a centralized messaging system, a decentralized messaging system, or a variation of the like. Typically, a centralized messaging system includes a central authoritative service including one or more servers that manage access to the messaging system, authenticate users of the messaging system, and manage resources of the messaging system such as contact lists and user preferences. Examples of centralized instant messenger systems include Windows Live Messenger™, America Online Instant Messenger™, Yahoo Instant Messenger™ and so forth.

Typically, a decentralized messaging system does not include a central authoritative service and may allow a user to host a local messaging server and connect the local messaging server to the decentralized messaging system. Jabber™ is an example of a decentralized instant messenger system.

In FIG. 1, instant messenger service 140 is a centralized messaging system. Note that instant messenger service 140 could be implemented in a decentralized messaging system.

Instant messenger services may use various methods to successfully establish a connection between two or more users. These various methods may include relaying messages between users or enabling a direct connection between users so that a user can send a message directly to a different user. Further, these various methods may include logic for negotiating firewalls, NAT boxes and so forth. It is not important how instant messenger services establish a connection. Instant messenger services such as instant messenger service 140 support the above mentioned relaying of messages and enabling of direct communication between users. For example, Windows Live Messenger™ supports relaying a message between one or more users or enabling direct communication between the one or more users. Note that security settings of each user's local area network may determine which method is used.

Instant messenger services such as instant messenger service 140 typically use unique identifiers to uniquely identify individual users of the service. In FIG. 1, such unique identifiers are illustrated by unique identifiers 114, 130, 150 and 162. A user of the instant messenger service keeps unique identifiers of other users in a contact list, such as contact lists 120, 134, 154 and 166. Contact lists are typically managed by the instant messenger service. In FIG. 1, contact list manager 144 manages contact lists 120, 134, 154 and 166 by providing the contact lists to the appropriate users when requested by the users, and storing the contact lists when the users are not online.

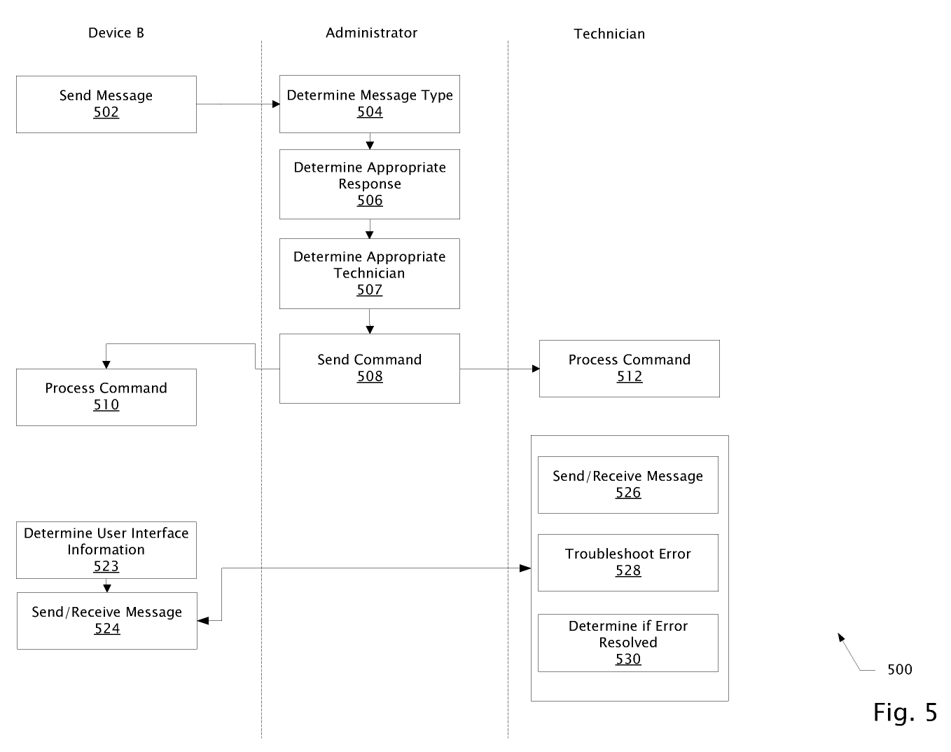

Instant messenger services such as instant messenger service 140 also typically provide presence or status information of users included in an individual's contact list. For example, when one of the users included in the individual's contact list is online, the individual is typically alerted by instant messenger service 140 and is able to initiate a chat session with the user. Status information may include but is not limited to data indicating when a user in the individual's contact list is offline, busy, idle, away and so forth. For example, Device A 104 may update its status information to “need a technician” so administrator 158 is aware Device A 104 needs a technician. FIG. 5 discusses and illustrates how administrator 158 facilitates communication between devices and technicians as mentioned in FIG. 1.

### Administered Devices

Device A 104 and Device B are shown in local area network 102. Device A 104 is operatively connected to local computing device 110. Local computing device 110 may include, but is not limited to, personal computers, servers, hand-held or laptop devices, personal digital assistants (PDA), cellular telephones and the like.

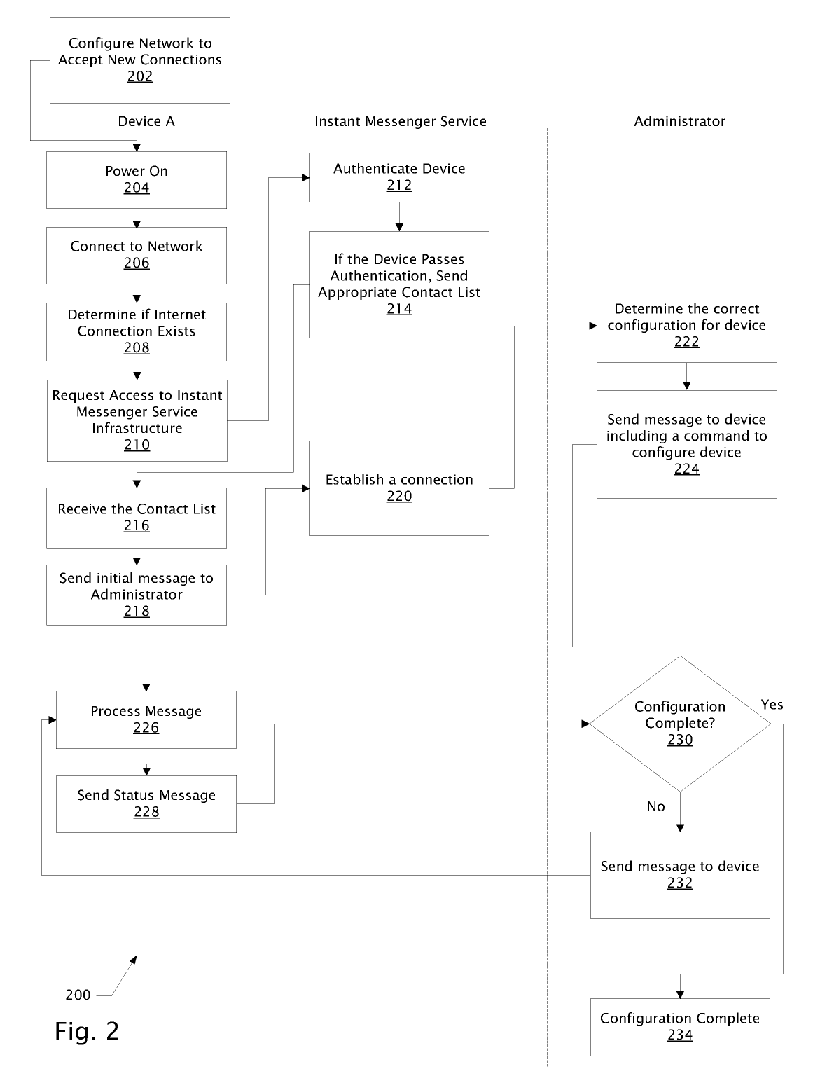

Local computing device 110 is operatively connected to router 136. Device A 104 is operatively connected to router 136 via local computing device 110. Device B 122 is operatively connected to router 136. FIG. 2 discusses and illustrates how devices are connected to instant messenger service 140 as discussed in FIG. 1.

Although FIG. 1 illustrates Device A 104, Device B 122, and local computing device 110 connected to the Internet 138 through router 136, other implementations are also suitable. For example, they may be connected using other networking devices including a hub, a server, a switch and the like. Similarly, the may connect directly to the Internet 138 if they incorporate the appropriate functionality. How Device A 104, Device B 122, and local computing device 110 are connected to the Internet 138 is not important as long as network connectivity is available so that the devices can communicate with instant messenger service 140, administrator 158, and/or resource 146. It is also not important how such connectivity is physically achieved and wired, wireless, or other types of physical connectivity may be used in accordance with the desired implementation.

Router 136 is operatively connected to the Internet 138 which is operatively connected to instant messenger service 140, administrator 158, and resource 146.

Device A 104 and Device B 122 may include, but are not limited to, microprocessor-based systems, multiprocessor systems, set top boxes, gaming consoles, consumer electronics, robots, and the like. Note that each of the above mentioned types of devices may be autonomous in that they perform actions in response to command or programming.

Devices that are administered via an instant messenger service are connected to instant messenger service 140 by a client instant messenger service. In FIG. 1, client instant messenger service 112 and 128 connect Device A 104 and Device B 122 respectively to instant messenger service 140. Note that in the case of Device A 104, the client instant messenger service 112 resides on a separate device, illustrated in FIG. 1 as local computing device 110. In the case of Device B 122, client instant messenger service 128 resides on Device B 122. It does not matter where a client instant messenger service resides as long as one exists that allows a device to communicate via instant messenger service 140.

Client instant messenger services such as client instant messenger services 112 and 128 use unique identifiers 114 and 130 to access instant messenger service 140. As previously mentioned, in instant messenger services, these are typically kept in a contact lists which, in centralized messaging systems are usually stored with the instant messenger service and sent to the client when the client is online.

In FIG. 1, client instant messenger services 112 and 128 include contact modules 118 and 132 respectively to receive contact lists 120 and 134 from instant messenger service 140. In FIG. 1, contact lists 120, 134 both initially include unique identifier 162, which corresponds to administrator 158. The purpose of initially including unique identifier 162 in contact lists 120, 134 is to allow administrator 158 to configure Device A 104 and Device B 122 after Device A 104 and Device B 122 access instant messenger service 140 for the first time. FIG. 2 discusses and illustrates how administrator 158 configures devices as discussed in FIG. 1.

Contact lists 120, 134 may also include the unique identifiers of any other entity that can communicate with Device A 104 and Device B 122. Further, contact lists 120, 134 do not have to initially include any unique identifiers. For example, contact lists 120, 134 may initially include no unique identifiers. After Device A 104 and Device B 122 access instant messenger service 140, Device A 104 and Device B 122 may receive a message from administrator 158 requesting to add unique identifier 162 to contact lists 120, 134. It does not matter what unique identifiers are initially included in contacts lists. However, in embodiments where a fixed list is not desired, the ability to update contact lists with additional unique identifiers should be included.

Device A 104 and Device B 122 are shown having firmware 106, 124 and software applications 108, 126, respectively. Device A 104 and Device B 122 are not required to include both firmware 106, 124 and software applications 108, 126, respectively.

If Device A 104 and/or Device B 122 are microprocessor based systems, firmware 106, 124 may include a basic input/output system (BIOS), instructions for loading necessary software routines to initialize a device for operation, instructions for loading necessary software routines to load software applications 108, 126 and the like. Note that firmware 106, 124 may be stored in a read-only memory (ROM), a random access memory (RAM), an electrically erasable programmable read-only memory (EEPROM), a flash memory and the like. Alternatively or additionally, firmware 106, 124 may include programming to perform functions of the device and/or any of the functionality described in conjunction with software applications below.

Software applications 108, 126 include but are not limited to executable code for operating Device A 104 and Device B 122 to perform an action in response to a received message via the instant messenger service 140. Further, software applications 108, 126 include logic for sending a message via instant messenger service 140. Software applications 108, 126 may be stored in a read-only memory (ROM), a random access memory (RAM), an electrically erasable programmable read-only memory (EEPROM), a flash memory, a hard drive and the like. As previously described, firmware 106, 124 may perform the above mentioned functionality.

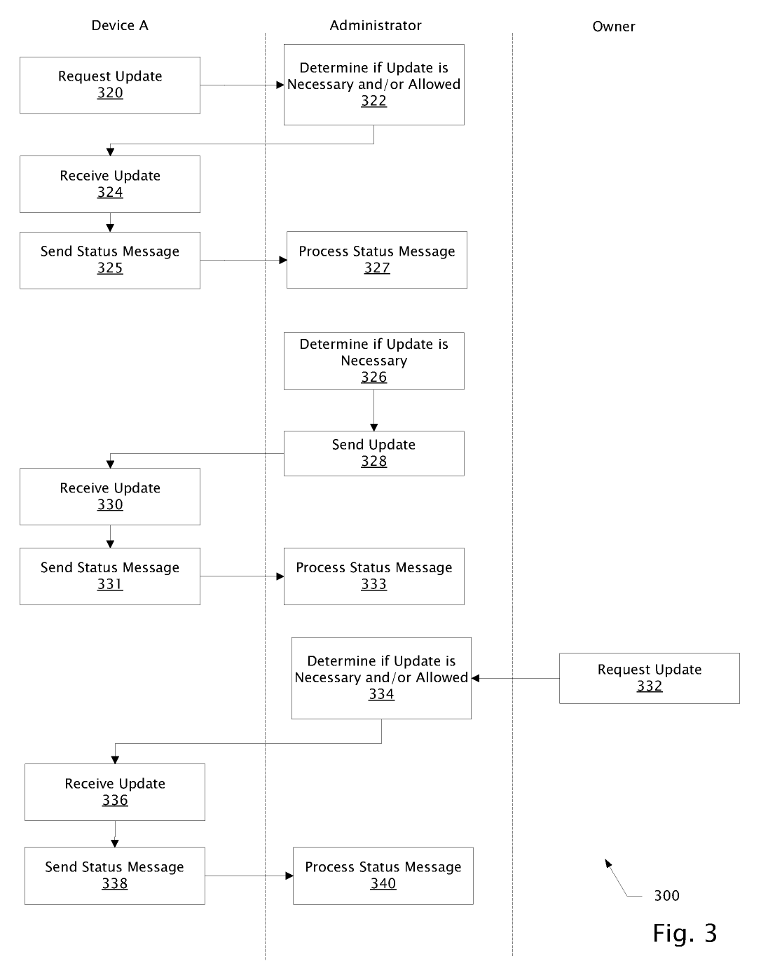

Both firmware 106, 124 and software applications 108, 126 may be updated by administrator 158 via instant messenger service 140. FIG. 3 discusses and illustrates how administrator 158 updates firmware 106, 124 and/or software applications 108, 126 as discussed in FIG. 1.

### Client Instant Messenger Service Add-In Modules

Client instant messenger services may be extensible to interact with other applications. In FIG. 1, client instant messenger services 112, 128 include add-in modules 116, 131 which receive software libraries 117, 133 that allow firmware 106, 124 and/or software applications 108, 126 to interact with client instant messenger services 112, 128. Examples of this interaction may include but are not limited to firmware and/or software applications receiving and sending one or more messages transmitted from/to client instant messenger services 112, 128 via instant messenger service 140.

Typically, software developers create one or more software libraries that include logic to access data transmitted to client instant messenger services via an instant messenger service. Further, these software libraries process the data and provide the data and/or additional information to device firmware and/or device software applications for further processing. For example, Windows Live Messenger™ supports an add-in module for receiving one or more software libraries. These software libraries may include logic that processes data received by client instant messenger services and then transmits the data and/or additional information to device firmware and/or software applications. Further, these software libraries may include one or more methods that manipulate the received data, process it, and transmit it to firmware and/or software applications. In FIG. 1, software libraries 117, 133 process messages received from administrator 158 via instant messenger service 140, and transmit the data and/or additional information to firmware 106, 124 and/or software applications 108, 126. The firmware 108, 126 and/or software applications 108, 126 process the data and/or additional information and perform an action in response to the received data.

These software libraries also process data received from device firmware and/or software applications, and transmit the data and/or additional information via instant messenger services using client instant messenger services to other users of the instant messenger services. In FIG. 1, software libraries 117, 133 process data received from firmware 108, 126 and/or software applications 108, 126 and transmit the data and/or additional information via instant messenger service 140 using client instant messenger services 112, 122 to administrator 158. Note software libraries 117, 133 may include all the logic of firmware 106, 124 or software applications 108, 126, which could result in not having firmware 106, 124 or software applications 108, 126.

### Alternate Implementation to Using Add-In Modules

In an alternate implementation, client instant messenger services 112, 128 may use an embedded web browser application (not shown) to interface with firmware 106, 124 and/or software applications 108, 126. The embedded web browser application may support web scripting such as JavaScript, Visual Basic Script and so forth. For example, Windows Live Messenger™ supports running an activity which includes a fully functional instance of Microsoft Internet Explorer™. The instance of Microsoft Internet Explorer™ supports web scripting and may support Decentralized Software Services (DSS) and Concurrent and Coordination Runtime (CCR). A web script running in the instance of Microsoft Internet Explorer™ may include logic to process messages sent to client instant messenger services 112, 128 via instant messenger service 140. Utilizing DSS and CCR, the web script may include logic to process messages sent to client instant messenger services 11, 128 from firmware 106, 124 and/or software applications 108, 126. Note DSS and CCR are examples of services that provide functionality that enable firmware and/or software applications to communicate via instant messenger services but are not the only options. Other services and/or logic supported by web browsers may be used in place of and/or in conjunction with DSS and CCR.

### Administrator

Administrators send messages to devices via instant messenger services using client instant messenger services. In FIG. 1, administrator 158 is shown having client instant messenger service 160. Client instant messenger service 160 may be running on a local computing device (not shown). The local computing device (not shown) may include a personal computer, a laptop, a server, a personal digital assistant (PDA), a cellular phone and the like.

Client instant messenger service 160 includes unique identifier 162 and contact module 164 for receiving contact list 166 from instant messenger service 140. Administrator contact lists may initially include one or more unique identifiers corresponding to devices that the administrators are responsible for administering. Further, administrator contact lists may include resources available to the administrators, such as technicians. In FIG. 1, contact list 166 includes unique identifiers 114, 130 and 150.

Administrators cause devices to perform various actions by sending one or more messages to the devices via instant messenger services. For example, administrators may send a message to a device that causes the device to update its firmware and/or software application. FIG. 3 discusses and illustrates how administrator 158 updates firmware 106, 124 and/or software applications 108, 126 as discussed in FIG. 1. Administrators also receive messages from devices that request various actions be performed. For example, administrators may receive a message from a device that includes a request to update the device's firmware and/or software application. This is also discussed in conjunction with FIG. 3.

Also, administrators may receive messages from devices that include alerts related to device errors. For example, administrators may receive a message from a device that includes an alert that the device experienced a firmware and/or software application error. As a result, administrators may facilitate communication between the device and a technician that can troubleshoot the software application error. FIG. 5 discusses and illustrates how Device B 122 sends an alert as a result of a software application error to administrator 158, and how administrator 158 facilitates communication between Device B 122 and a technician that can troubleshoot the software application error.

Administrators may also log messages sent to and from devices and/or resources to a database (not shown). The messages saved to the database (not shown) may be processed for use in automatically administering devices, determining trends in types of messages sent/received and so forth. Such logging can be used in any manner and the details are beyond the scope of the present disclosure.

### Resources

Resources interact with devices and provide additional services for both administrators and/or devices via instant messenger services. In FIG. 1, resource 146 is shown having client instant messenger service 148 which includes unique identifier 150 and contact module 152 for receiving contact list 154. Contact list 154 includes unique identifier 162.

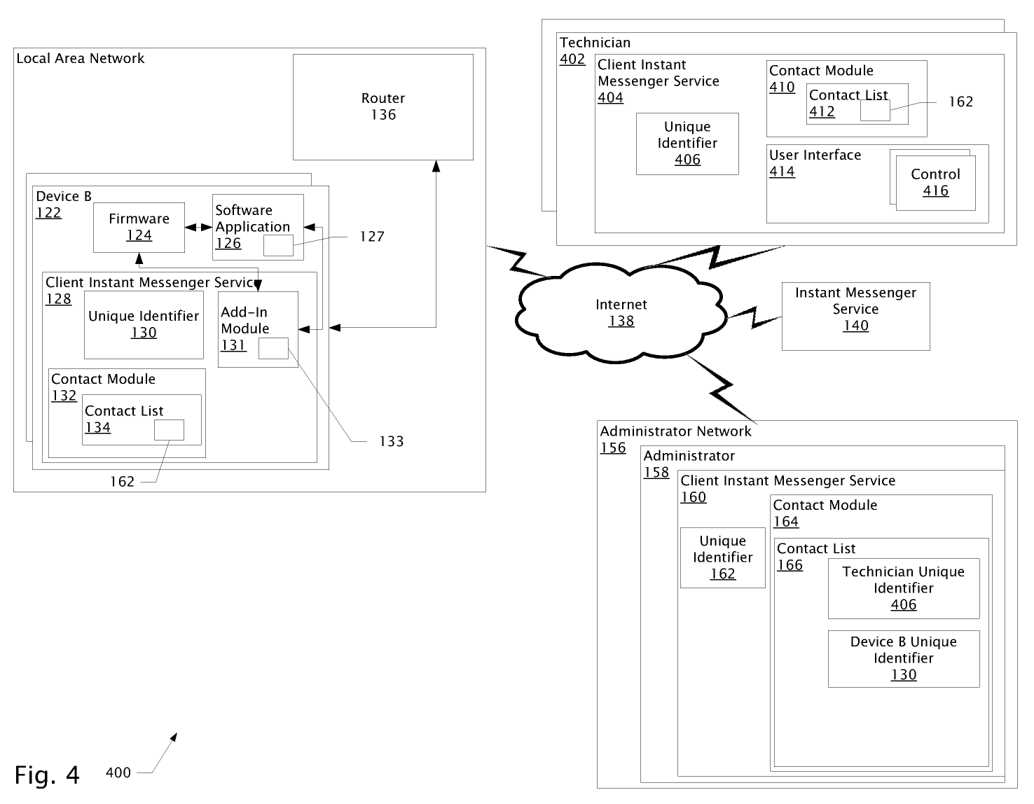

Resources interact with devices and provide additional services for both administrators and/or devices. Resources may include but are not limited to humans (such as an administrator like administrator 158 of FIG. 1, technicians like technician 402 of FIG. 4 or others), web services (such as those that might be configured to monitor, record and/or respond to messages to/from devices), other devices and so forth. Basically a resource can be anything that communicates with a device over an instant messenger service.

### Device Configuration

FIG. 2 is a flow chart 200 depicting an example in the context of FIG. 1 of connecting Device A 104 to instant messenger service 140, and administrator 158 so that administrator 158 may configure Device A 104 via instant messenger service 140. The flow chart 200 depicts only one example of an implementation for connecting a device to an instant messenger service and for an administrator to configure a device using an instant messenger service, and is not intended to limit the examples described in this application to this particular implementation.

In the following description of FIG. 2, continuing reference is made to elements and reference numerals shown and described in FIG. 1.

Consider the scenario where a device first connects to a network. In such a situation the network may need to be configured to accept new connections. Further, after the device is connected to the network, an administrator may be the first point of contact to configure the device, update software running on the device, and so forth. Such a scenario would be useful, for example, where devices are consumer electronics type devices to relieve the consumer from having to perform any configuration and/or maintenance of the devices. Additionally, it is useful for other devices such as robots to allow an administrator to initially configure them, maintain them and so forth.

### Configure Local Area Network to Accept New Connections

When connecting a new device so that it can be communicate via instant messenger, the local area network may need to be configured to accept new connections from devices. For example, in FIG. 1 to initially connect Device A 104 to local area network 102, connections are made between Device A 104, local computing device 102, and router 136. At block 202, router 136 is configured to accept new connections. In the implementation described in FIG. 1, router 136 is configured to accept dynamic host configuration protocol (DHCP) connections. Local computing device 110 is operatively connected to router 136 via DHCP. Router 136 is, in turn, operatively connected to the Internet 138. Device A 104 is operatively connected to local computing device 110 and uses local computing device's 110 connection to router 136 to access the Internet 138. Note that configuring local area network 102 to accept new connections is not limited to enabling DHCP and may include further steps depending on other networking devices (not shown) and applications (not shown) running on local area network 102.

### Connect Device A to Instant Messenger Service

Devices may require minimal configuration to connect them to instant messenger services. In the case of devices discussed in FIG. 1, these devices have owners and/or users. The owners and/or users of devices typically receive devices from manufacturers, distributors, retail stores and so forth. The owners and/or users of a device remove it from its packaging, install a suitable power supply (if necessary) or charge the included batteries of the device, and turn on the device. It is not important who the owners and/or users are or if the devices have owners and/or users. However, any configuration needed, including powering devices on/off, should be performed. Further, software may need to be installed on a local computing device such as local computing device 110 to enable Device A 104 to communicate via instant messenger service 140. At block 204, Device A 104 is powered on. Device A firmware 106 initializes Device A 104 for operation.

Device firmware and/or software applications may be configured to search for local area networks and automatically connect to the local area network. At block 206, firmware 106 searches for a local area network and connects Device A 104 to local area network 102 via local computing device 110. At block 208, firmware 106 determines if an Internet connection is available via local area network 102. If an Internet connection does not exist, the firmware 106 continues searching for a different local area network that may have an Internet connection.

Once a device has a connection to the Internet, the device attempts to access an instant messenger service. At block 210, Device A 104 sends a request to instant messenger service 140 to access the messaging system.

Typically, instant messenger services authenticate users before granting users access to the instant messaging system. At block 212, instant messenger service 140 receives the request for access from Device A 104 and authenticates Device A 104. Instant messenger service 140 may authenticate Device A 104 using various methods. For example, instant messenger service 140 may compare unique identifier 114 and a corresponding password (not shown) to a list of authorized users stored in a database (not shown) and grant access appropriately.

Once instant messenger services successfully authenticate a user, the instant messenger services typically sends the user's contact list to the user. At block 214, once Device A 104 is successfully authenticated, instant messenger service 140 sends Device A 104 contact list 118. At block 216, Device A 104 receives contact list 118.

After receiving a contact list, a user is able to initiate communication with other users included in the received contact list. Note that the user is able to request communication with other users not included in the received contact list but typically the other users accept an invitation from the user before communication can begin.

Device A 104 is able to communicate with users of instant messenger service 140 that are included in contact list 118. Contact list 118 may include unique identifier 162 to allow Device A 104 to communicate with administrator 158 via instant messenger service 140. At block 218, Device A 104 sends an initial message to administrator 158 in order to allow administrator 158 to determine the appropriate configuration for Device A 104 and configure Device A 104 via instant messenger service 140.

Typically, instant messenger services establish a connection between two or more users by negotiating firewalls and NAT boxes and successfully enabling communication between the two users. At block 220, instant messenger service 140 establishes a connection between Device A 104 and administrator 158 and enables the initial message to be sent to administrator 158.

### Administrator Configures Device A Via Instant Messenger Service

After receiving the initial message from a device, administrators determine the correct configuration for the device. The configuration may be determined by a service package purchased by the owner and/or user of the device that includes administrative support of the device by an administrator. The configuration may also be determined by the model and/or type of device. At block 222, administrator 158 receives the initial message from Device A 104 and determines the correct configuration for Device A 104. At block 224, administrator 158 sends a message to Device A 104 including one or more commands for configuring Device A 104. Note that the message may include additional executable code and the like.

Devices receive messages that include commands for configuration, and the firmware and/or software applications process the commands. One or more software libraries enable firmware and/or software applications to send and/or receive data via instant messenger services. At block 226, Device A 104 receives the message from administrator 158 including one or more commands for configuration and processes the message. Device A 104 processes the message using, for example, software library 117 and firmware 106 and/or software application 108.

Although not required, devices may send status updates of the progress of the commands sent by administrators to be executed by the devices. At block 228, Device A 104 sends a status to administrator 158 of one or more commands processed by Device A 104.

Administrators receive the status updates and determine if further action needs to be taken including sending additional messages to the devices. For example, if a status update from a device includes errors, administrators may restart or continue configuration of the device by re-sending previous messages for configuration or taking other corrective action. The status of the commands processed may include details such as complete, in progress, need more information, error and so forth. At block 230, administrator 158 processes the status updates of one or more commands processed by Device A 104 and determines if configuration of Device A 104 is complete. At block 232, if administrator 158 determines configuration of Device A 104 is not complete, administrator 158 sends additional messages including commands to continue configuring Device A 104. At block 234, if administrator 158 determines configuration of Device A 104 is complete, administrator 158 stops sending commands to configure Device A 104.

Update Device A Firmware and/or Software Application

As previously mentioned, software and/or firmware may be updated on a device using instant messenger communications, either as part of initial configuration or other maintenance of the device. FIG. 3 is a flow chart 300 depicting an example in the context of FIG. 1 of an administrator updating a firmware and/or software application running on a device using an instant messenger service. The flow chart 300 is only one example of an implementation for an administrator to update a firmware and/or software application running on a device via an instant messenger service and is not intended to limit the examples described in this application to this particular implementation. Note a web service may also update a firmware and/or software application running on a device similarly to how an administrator updates them.

In the following description of FIG. 3, continuing reference is made to elements and reference numerals shown and described in FIG. 1.

Device A Requests Update to Firmware and/or Software Application

Firmware and/or software applications running on devices may be configured to periodically request updates from administrators. Alternatively or additionally, administrators can proactively send firmware and/or software updates to a device without request. These updates may include executable code, software patches that fix problems in the firmware and/or software applications, additional features to include in the firmware and/or software applications that provide functionality to the devices and so forth. At block 320, the firmware 106 and/or software application 108 send a message to administrator 158 including a request for an update to firmware 106 and/or software application 108.

Administrators receive these requests for update to firmware and/or software applications and determine if the updates are necessary and/or authorized. For example, owners and/or users of devices may need to pay fees to administrators or affiliated business entities in order to receive updates to firmware and/or software applications running on the devices. At block 322, administrator 158 receives the request for the update and determines if the update is necessary and/or authorized. If the request is necessary and/or allowed, administrator 158 sends the update to Device A 104 via instant messenger service 140.

Devices receive and process updates to firmware and/or software applications similarly to how they receive and process commands for configuration as discussed in FIG. 1 and FIG. 2. At block 324, Device A 104 receives the update from administrator 158, and firmware 106 and/or software application 108 process the update.

Again, although not required, devices may send status updates about the processing of the updates to administrators similarly to how they send status updates related to processing of configuration commands as described in FIG. 2. At block 325, Device A 104 sends a status update message to administrator 158 including details on the status of the update.

Administrators receive and process these status updates similarly to how they receive and process status updates as discussed in FIG. 2. At block 327, administrator 158 receives the status of the update and processes the status. If the status indicates that the update was unsuccessful, administrator 158 may attempt to resend the update or take other corrective action. If the status indicates the update was successful, administrator 158 may log the update as complete in a database (not shown) and stop sending messages that update Device 104 or take any other desired actions.

Administrator Determines If Update to Firmware and/or Software Application is Necessary

Administrators may periodically determine when firmware and/or software applications of devices were last updated without the devices requesting an update. At block 326, administrator determines if an update for Device A 104 is necessary.

This process proceeds largely as described previously with communications between the device and administrator or web service responding as previously described. As described above, if an update is necessary, administrators send the update via instant messenger services to the devices, the devices process the received updates, send status and the administrator takes additional actions if desired or necessary. These are illustrated in blocks 326, 328, 330, 331 and 333 respectively. At block 326, administrator 158 determines an update is necessary. At block 328, administrator 158 sends the update to Device A 104 via instant messenger service 140. At block 330, Device A 104 receives the update from administrator 158 and processes the update. At block 331, Device A 104 sends a status message to administrator 158 regarding the status of the update. At block 333, administrator 158 receives the status update message and processes the message.

Owner and/or User of Device A Requests Update to Firmware and/or Software Application

Owners and/or users of devices may also request administrators update the devices. Owners and/or users may send these requests using a variety of methods. For example, owners and/or users may call administrators, submit requests to administrators via a web site, send a text message via a cell phone to administrators, send a message via instant messenger services to administrators and so forth. It is not important how the owners and/or users send the request to administrators. However, administrators should receive the request from them in some form. At block 332, owner of Device A 104 requests an update for Device A 104.

This process proceeds largely as described previously with communications between the device and administrator or web service responding as previously described. As described above, administrators may receive requests for updating firmware and/or software applications running on devices and process the requests by determining if the update is necessary and/or authorized, administrators send the update via instant messenger services to the devices, the devices process the received updates, send status and the administrator takes additional actions if desired or necessary. These are illustrated in blocks 334, 336, 338 and 340 respectively. At block 334, administrator 158 receives the request from the owner of Device A 104 and processes the request by determining if Device A 104 needs an update and/or if the update is authorized. At block 336, Device A 104 receives the update from administrator 158 via instant messenger service 140 and processes the update. At block 338, Device A 104 sends a status of the update to administrator 158. A block 340, administrator 158 receives the status of the update and processes the message.

General Environment Including Technician that Troubleshoots Device B

FIG. 4 illustrates an example implementation of a technician troubleshooting a device via an instant messenger service. The implementation in FIG. 4 has been deliberately expanded to illustrate various aspects that are possible with the instant disclosure. Not all of the elements illustrated in FIG. 4 are required in every embodiment and the various elements may be put together in different ways to implement different systems.

In one aspect, FIG. 4 illustrates an exemplary environment 400 for an administrator using an instant messenger service to facilitate communication between a device and a technician or other service that will troubleshoot device. The exemplary environment 400 is only one example of an implementation for an administrator using an instant messenger service to facilitate communication between a device and a technician that will troubleshoot the device, and is not intended to limit the examples described in this application to this particular implementation. In the following description of FIG. 4, continuing reference is made to elements and reference numerals shown and described in FIG. 1.

### Technicians

Technicians are a type of resource that troubleshoot devices by sending messages to devices via instant messenger services that cause the devices to perform various actions. In FIG. 4, technician 402 may be a person shown having client instant messenger service 404 which includes unique identifier 406. Alternatively, the technician may be some sort of automated service where troubleshooting and/or corrective action can be accomplished without human intervention. In yet a further embodiment, the technician may be some combination of automated and human resources that are able to troubleshoot and/or take corrective actions. Client instant messenger service 404 also includes contact module 410 for receiving contact list 412.

### Administrator Facilitates Communication Between Device B and Technician

In a situation where a device does not have within its contact list the unique identifier of a technician, mechanisms should be included that allow the device to acquire such a unique identifier. This can be accomplished in a variety of ways both automated and non-automated. In one embodiment, an administrator may facilitate communication between devices and/or resources by sending messages to devices and/or resources via instant messenger services that configure or request updates to the devices and/or resources contact lists. As a result, configuring devices to communicate with other devices and/or resources may be accomplished by adding unique identifiers to contact lists to enable devices to communicate with a variety of resources.

Consider the case when an administrator wants to enable communication between a device and a resource. The device may not be aware the resource exists. The administrator sends a command to configure the device's contact list to include the unique identifier of the resource, enabling the device and resource to communicate with each other via an instant messenger service. The administrator did not have to follow any complicated configuration steps. Further, the administrator did not need to know anything about the respective network configurations of the device and the resource to enable communication.

Referring specifically to FIG. 4, administrator 158 facilitates communication between Device B 122 and technician 402 by sending one or more messages to Device B 122 to configure contact list 134 to include unique identifier 406. Administrator 158 configures contact list 134 to include unique identifier 406. Alternatively and/or additionally administrator 158 may also send a message to technician 402 requesting technician 402 add unique identifier 130 to contact list 412. Note that Device B 122 may send a request to technician 402 for technician 402 to add unique identifier 130 to technician contact list 412. Further, administrators may send one or more unique identifiers associated with various technicians to devices before the technicians are needed by the devices. As a result, when devices eventually need a technician, logic in firmware and/or software applications running on the devices may select an appropriate technician already included in the contact lists and/or contact each of the already included technicians until one that is contacted is available to troubleshoot the device.

### User Interfaces

Human technicians typically want to use user interfaces to interact with devices that provide rich visual experience to administer the devices to simplify interactions with the device. Client instant messenger services may include user interfaces to allow human administrators and technicians to interact with devices. Note that client instant messenger services are not required to include such user interfaces since technicians could control the devices sending commands via instant messenger services using plain text. However, rich user interfaces may result in an easier, less error prone, more desirable experience.

User interfaces typically include one or more controls for interacting with devices. These controls may be web scripts, Active-X components, images, buttons, text boxes and so forth. It is not important what types of controls are implemented in user interfaces. Rather, it is desirable users are able to interact with user interfaces to administer devices via instant messenger services. Client instant messenger service 404 includes user interface 414. Technician 402 uses user interface 414 to configure, update or control Device B 122 via control 416. Note that user interface 414 may be an embedded web browser application running inside the technician client messenger service 404. For example, Windows Live Messenger™ supports using an embedded instance of Microsoft Internet Explorer™ that may be used as a user interface. Control 416 may be various user interface controls that are able to run in Microsoft Internet Explorer™.

### Device B Provides User Interface Information

Devices provide information to human technicians to allow these technicians to interact with the devices using a user interface. For example, in response to a specific error, a device may determine an appropriate user interface for potential technicians to use to start troubleshooting the error and send the user interface information to the technicians. In FIG. 4, Device B 122 sends technician 402 one or more messages including user interface information 127 that determines how client instant messenger service 404 displays user interface 414. Further, user interface information 127 may also determine what type of and the quantity of controls 416 that may be included in user interface 414 so that technician 402 can troubleshoot Device B 122 appropriately. Firmware 124 and/or software application 126 determines the appropriate user interface information 127 for technician 402 to use to interface with Device B 122. User interface information 127 may be related to the status of Device B 122. For example, if Device B 122 is experiencing errors with a specific function, software application 126 may determine a particular set of controls specific to that function are appropriate for the technician to start troubleshooting the device. As a result, user interface information 127 will include information for user interface 414 to display one or more controls 416. Note technician 402 may request user interface information 127 from Device B 122 that is preferred by technician 402 and is not specific to a status of Device B 122.

### Technician Troubleshoots Device B

Consider the case when firmware and/or software running on a device experience an error. As a result, the device is unable to function properly. Technicians (both human and non-human) may troubleshoot these errors via instant messenger services. FIG. 5 illustrates one example how technicians may troubleshoot devices via instant messenger services.

### Administrator Facilitates Communication Between Device B and Technician

FIG. 5 is a flow chart 500 depicting an example in the context of FIG. 4 of an administrator using an instant messenger service to facilitate communication between the device and a technician that will troubleshoot the device. The flow chart 500 is only one example of an implementation for an administrator using an instant messenger service to facilitate communication between the device and a technician that will troubleshoot the device, and is not intended to limit the examples described in this application to this particular implementation.

In the following description of FIG. 5, continuing reference is made to elements and reference numerals shown and described in FIG. 1 and FIG. 4.

### Device B Sends Alert to Administrator

When firmware and/or software applications running on a device experience an error, the device may send an alert including the error to administrators. At block 502, Device B 122 sends a message to administrator 158 including an alert.

Administrators receive these alerts and process them similarly to how they process requests for updates for firmware and/or software applications as described in FIG. 3. At block 504, administrator 158 determines the message type sent by Device B 122.

After administrators process the alerts, they determine an appropriate action to perform. For example, an administrator may determine that technicians are needed to fix the error. At block 506, administrator 158 determines an appropriate response. At block 507, administrator 158 determines the appropriate technician 402. At block 508, administrator 158 sends a command via instant messenger service 140 to update both contact lists 134 and 412 to include unique identifier 406 and unique identifier 130 respectively. At block 512, technician 402 updates contact list 412 to include unique identifier 130. At block 510, Device B 122 updates contact list 134 to include unique identifier 406.

### Device B Sends User Interface Information to Technician

Devices may determine appropriate user interface information to send technicians that determine how user interfaces are displayed and what type of controls are included. At block 523, Device B 122 determines appropriate user interface information 127 to send to technician 402. At block 524, Device B 122 sends a message to technician 402 including user interface information 127.

### Technician Troubleshoots Device B

Technicians receive user interface information from devices that provide an initially starting point to begin troubleshooting the devices. Note that technicians are not required to use the user interface information provided by devices, and may use a standard user interface corresponding to the type or model of the device being repaired. At block 526, technician 402 receives the message from Device B 122 that includes user interface information 127 for displaying one or more controls in user interface 414.

Technicians send one or more messages and/or utilize user interfaces to interact with and troubleshoot the devices via instant messenger services. Once the errors are resolved, the technician stops troubleshooting the device. At block 528, technician 402 troubleshoots one or more errors associated with Device B 122 and utilizes user interface 414 to troubleshoot, configure, update, and/or control Device B 122. At block 530, technician 402 determines if one or more errors associated with Device B 122 are resolved. If one or more errors are resolved, technician 402 stops sending messages to Device B 122. If the one or more errors are not resolved, technician 402 continues to troubleshoot the one or more errors.

Although some particular implementations of systems and methods have been illustrated in the accompanying drawings and described in the foregoing Detailed Description, it will be understood that the system and methods shown and described are not limited to the particular implementations described, but are capable of numerous rearrangements, modifications and substitutions without departing from the spirit set forth and defined by the following claims.

What is claimed is:

1. A device comprising:
a firmware and/or a software application executable by the device;
a first client instant messenger service including a contact module;
a device identification tag for use by the first client instant messenger service to identify the device to an instant messenger service; and
a device contact list, received by the contact module from the instant messenger service, the device contact list including at least one identification tag used by the device to communicate with a resource identified by the at least one identification tag.

2. The device of claim 1, wherein the first client instant messenger service includes an add-in module to receive a software library.

3. The device of claim 2, wherein the software library is used by the first client instant messenger service to communicate with the firmware and/or software application.

4. The device of claim 3, wherein the software library includes one or more methods to process a message received by the device client instant messenger service and to transmit the processed message to the device firmware and/or the device software application for further processing.

5. The device of claim 3, wherein the software library includes one or more methods to process a message sent by the device firmware and/or the device software application and to enable the device client instant messenger service to send the processed message via the instant messenger service.

6. The device of claim 1, wherein the firmware and/or software application is configured to generate user interface information and send the user interface information via the instant messenger service.

7. The device of claim 6, wherein the user interface information includes data that determines how a user interface is displayed, the data corresponding to an error associated with the firmware and/or software application.

8. A method for controlling a device using an instant messenger service comprising:
receiving a contact list via the instant messenger service including at least one identification tag associated with a device having a device contact list;
sending a message to the device via the instant messenger service which, when received by the device, causes the device to perform an action specified in the message; and
receiving a message via the instant messenger service communicating the status of the action.

9. The method of claim 8, wherein the sent message includes a command to configure the device that causes the device to modify a setting of a firmware and/or a software executing on the device.

10. The method of claim 8, wherein the sent message includes an update for a firmware and/or a software application executing on the device.

11. The method of claim 8, wherein the sent message includes a command to control the device.

12. The method of claim 8, further comprising displaying either the sent message, the received message, or both in a user interface.

13. The method of claim 12, wherein the user interface includes at least one control which causes a message to be sent to the device.

14. The method of claim 12, wherein the user interface includes at least one control which supports running a web browser.

15. The method of claim 8, further comprising logging the sent message to a database.

16. The method of claim 8, wherein the sent message includes a command to add an identification tag associated with a resource to the device contact list.

17. The method of claim 16, wherein the resource is a web service.

18. The method of claim 8, further comprising sending a message to a user via the instant messenger service requesting the user to add the device identification tag to a user contact list used by the user to communicate with contacts via the instant messenger service.

19. The method of claim 18, further comprising logging to a database one or more messages sent between the device and the user.

20. A device comprising:
means for receiving a message from an instant messenger service, the message to be processed at the device;
means for performing an action in response to the received message; and
means for sending a message to the instant messenger service, the message including a status of the action.
